(19) United States
(12) Patent Application Publication
(10) Pub. No.: US 2026/0102641 A1
(43) Pub. Date: Apr. 16, 2026

(54) Cable Tray Firestop Apparatus

(71) Applicant: Specified Technologies, Inc., Sommerville, NJ (US)

(72) Inventors: Steven Faiello, Morris Plains, NJ (US); James P. Stahl, Princeton Junction, NJ (US); Julio Lopes, Viera, FL (US)

(21) Appl. No.: 19/360,739

(22) Filed: Oct. 16, 2025

Related U.S. Application Data
(60) Provisional application No. 63/708,255, filed on Oct. 16, 2024.
(60) Provisional application No. 63/708,714, filed on Oct. 17, 2024.
(60) Provisional application No. 63/708,750, filed on Oct. 17, 2024.

(51) Int. Cl. A62C 3/16; H02G 3/04; H02G 3/22

(52) U.S. Cl. CPC A62C 3/16; H02G 3/0412; H02G 3/0418; H02G 3/0487; H02G 3/22

(57) ABSTRACT

An apparatus for firestopping a cable tray having a cable load and extending through a partition. A housing of the apparatus is constructed to envelope a portion of the cable tray within the partition and defines an axial passageway between open front and back sides of the housing through which the cable tray and cable load extend. Firestop pads are arranged along the inside of the housing. An actuator is connected to a top firestop pad and is operable to move the top firestop pad between a first position disengaged from the cable load, which allows the cable load to be altered without interference from the top firestop pad, and a second position engaged with the cable load, which firestops the passageway surrounding the cable load.

### CROSS REFERENCE TO RELATED APPLICATIONS

This application claims priority to U.S. provisional patent application no. 63/708,255, filed Oct. 16, 2025, entitled Cable Tray Firestop Device, and U.S. provisional patent application no. 63/708,714, filed Oct. 17, 2025, entitled Cable Tray Firestop Apparatus, and U.S. provisional patent application no. 63/708,750, filed Oct. 17, 2025, entitled Cable Tray Firestop Device, all of which are incorporated herein by reference.

### FIELD OF THE INVENTION

The present invention relates to an apparatus for providing a firestop within a construction partition passageway. More particularly, the invention relates to a cable tray firestopping apparatus having a firestop pad that can be moved between a first position engaged with the cable load and a second position disengaged from the cable load to make it easier to add to or subtract from the cable load.

### BACKGROUND OF THE INVENTION

It is commonplace in the construction and renovation of commercial and residential buildings to pass plumbing, electrical, communications and/or HVAC elements, such as pipes, conduit, wire, cable, etc. (“utility element”), through a floor, ceiling, wall, or other partition, from one floor or room to another. In one common application, communications cables are supported on a cable tray, which traverses the construction partition. Cable trays are mechanical support systems that provide a rigid structural system for electrical cables, raceways, and insulated conductors used for electric power distribution, control, signal instrumentation, and communication. The cable tray typically comprises an elongate support structure having a support surface with a pair of side walls to define a generally rectangular cable passage area with a U-shaped cross-section. Cable trays are provided in in many widths and heights.

As with other passageways through construction partitions, a cable tray is positioned within an opening through the partition, which also provides a passageway through which smoke and fire may spread from one floor or room to another during a fire. Because of this hazard, some form of fire barrier is normally located within or about the cable tray and is designed to prevent the passage of fire and smoke through that opening. Some conventional firestopping materials that have been packed into and/or around cable trays include mortars and sealants. One drawback to these materials is installation. Because these materials are installed in the field after the cable load has been installed through the cable tray, the integrity of the seal depends on the skill of the technician and adherence to the installation protocol. If those materials are not properly installed, the passageway through the cable tray is unknowingly firestop compromised. Moreover, installation of these firestopping materials in the field by a technician is more costly than installation on a manufacturing/assembly line. Therefore, it would be desirable to provide a cable tray firestopping device having firestopping means that are installed during manufacture of the cable tray under a quality control program.

Another drawback to conventional firestopping materials relates to removability. It is not uncommon during the lifespan of a building to change the cable load by increasing or decreasing the number of cables that pass through the cable tray. As usage increases or technology changes, the original cables may be replaced and/or supplemented several times. If the original cable load in a cable tray has been firestopped using curable materials such as mortars and sealants, those materials must be destructively removed with the attendant risk of damage to the cables and cost of re-installing those materials once the new cable load is installed. Therefore, it would be desirable to provide a cable tray firestopping device having firestopping means that can be non-destructively disengaged and reengaged with the cable load when it is replaced or supplemented.

Some prior art cable tray firestop assemblies use pre-formed, firestopping materials that can be disengaged from the cable load and removed from the cable tray without destruction if the original cable load in these cable trays requires modification. However, to do so, the firestop assembly must be disassembled to remove these pre-formed firestopping materials. The process of disassembling and reassembling the firestop assembly depends on the skill of the technician and adherence to the disassembly/reassembly protocol. If the firestop assembly is not properly reassembled, the passageway through the cable tray is unknowingly firestop compromised. Moreover, many firestop assemblies cannot be easily disassembled once the assembly is installed due to the spatial restraints of the passageway in the partition. For example, in order for a firestop assembly to work properly, the assembly must fit snugly within the partition passageway, which leaves no way of disassembling the device without removing it from the passageway. Therefore, it would be desirable to provide a cable tray assembly having firestopping means that can be easily removed from engagement with the cable load, and easily reinstalled with the cable load when the cable load is replaced or supplemented.

### SUMMARY OF THE INVENTION

The present invention provides a firestop apparatus for use within a passageway of a construction partition. The apparatus has particular use for surrounding a cable tray having a cable load. The apparatus has a housing defined by a U-shaped base and a top cover, which together define an axial passageway through which the cable tray and cable load extend. Firestop material is positioned on the inner surface of each housing panel. At least a portion of the firestop material is movable between a first or open position in which the movable firestop material is disengaged from the cable load and allows the cable load to be easily altered without interference from the movable firestop material, and a second or closed position in which the movable firestop material is engaged with the cable load and firestops the passageway surrounding the cable load. The movable firestop material is reconfigurable in the second position to accommodate different cable load sizes and geometries.

In one exemplary, preferred embodiment, the apparatus generally comprises a housing, firestop material lining the interior of the housing, and an actuator that is constructed and arranged to translate the movable firestop material between the first and second positions. The movable portion of firestop material preferably comprises a flexible pad made of an intumescent material and includes a compressible, intumescent foam pad.

The housing has top, bottom, and side panels, and a central, longitudinal axis. The housing is constructed to envelope a portion of the cable tray within the partition and defines an axial passageway between open front and back sides of the housing through which the cable tray and cable load extend. Fixed firestop material is arranged along the inside of at least one of the top, bottom and side panels and around the axial passageway. Movable firestop material is arranged along the inside of at least one of the top, bottom and side panels and around the axial passageway. The actuator is connected to the movable firestop material.

In preferred embodiments, the actuator comprises a guide fixed to one of the housing panels, and at least one movable bracket that reciprocates within the guide. The movable bracket may comprise a carriage to which the movable firestop material can be fixed, and arms connected to the carriage that slide within the guide.

In one exemplary preferred embodiment, the movable firestop material is a flexible pad. One edge of the flexible pad is fixed to the movable bracket and an opposed edge is fixed to the housing so that the flexible pad is configured into different geometries when the movable bracket is moved relative to the housing. In this embodiment, the actuator is only operable from one side of the housing.

In another exemplary preferred embodiment, the actuator is operable from either the front or back side of the housing. In this embodiment, the actuator comprises a pair of brackets that are movable relative to one another. Opposed edges of the flexible pad are fixed to one of the brackets so that the flexible pad is configured into different geometries when at least one of the brackets is moved relative to the housing. In this preferred embodiment, the brackets are constructed and arranged so that all of the arms slide within the guide, and the arms interdigitate within a common plane parallel to the panel to which the guide is fixed.

In one preferred embodiment, firestop material comprising intumescent pads are fixed to the bottom and side panels of the housing. Preferably, at least a portion of the fixed intumescent pads comprises a multi-layer pad having a layer of intumescent foam and a layer of compressible, fire-retardant foam. The multi-layer pads are fixed to the side panels of the housing.

In some preferred embodiments, the actuator is mounted on the top panel and is connected to opposed ends of the movable firestop material to suspend the movable firestop material above the bottom panel. The actuator is operable from either the front or back side of the housing, and is constructed and arranged to change the suspension of the movable firestop material to move it between a first position disengaged from the cable load, which allows the cable load to be altered without interference from the movable firestop material, and a second position engaged with the cable load, which firestops the passageway surrounding the cable load. In the second position, the movable firestop material is reconfigurable to accommodate different cable load sizes and geometries with which it engages.

### BRIEF DESCRIPTION OF THE DRAWINGS

FIGS. 1 and 2 are perspective views of an apparatus in accordance with an embodiment of the invention installed in the passageway and around a cable tray with cable load;

FIG. 3 is a top plan of the apparatus shown in FIG. 1;

FIG. 4 is a bottom plan of the apparatus shown in FIG. 1;

FIG. 5 front elevation of the apparatus shown in FIG. 1;

FIG. 6 is a side elevation of the apparatus shown in FIG. 1;

FIGS. 7 and 8 are exploded views of the apparatus of FIG. 1;

FIG. 9 is an enlarged, fragmentary view of the corner brackets shown in FIG. 1;

FIG. 10 is a bottom isometric view of the cover assembly of the apparatus of FIG. 1 in a closed limit position;

FIG. 11 is a side elevation of the cover assembly of the apparatus of FIG. 1 in a closed limit position;

FIG. 12 is a bottom isometric view of the cover assembly of the apparatus of FIG. 1 in an intermediate position between the open and closed limit positions;

FIG. 13 is a side elevation of the cover assembly of the apparatus of FIG. 1 in an intermediate position between the open and closed limit positions;

FIG. 14 is a bottom isometric view of the cover assembly of the apparatus of FIG. 1 in an open limit position;

FIG. 15 is a side elevation of the cover assembly of the apparatus of FIG. 1 in an open limit position;

FIG. 16 is an enlarged, fragmentary view of the slides on the slidable anchor panel of the apparatus of FIG. 1;

FIGS. 17-21 are isometric view illustrating the steps for installing the apparatus in a partition passageway around a cable tray;

FIG. 22 is an isometric view of an apparatus in accordance with another exemplary embodiment of the invention;

FIG. 23 is an isometric view of the apparatus of FIG. 22 in a partially open position;

FIG. 24 is a partial explosion of the apparatus of FIG. 22;

FIG. 25 is an isometric view of the apparatus of FIG. 25 in a partially open position with the top cover removed;

FIG. 26 is an isometric view of the means for selectively engaging and disengaging the top intumescent pad with a cable load;

FIG. 27 is a top plan view of the means shown in FIG. 26;

FIG. 28 is a cross-section taken along lines 28-28 of FIG. 27;

FIG. 29 is a bottom isometric view of the means of FIG. 26;

FIG. 30 is a partial explosion of the upper portion of the apparatus of FIG. 22;

FIG. 31 is a partial explosion of the lower portion of the apparatus of FIG. 22;

FIG. 32 is bottom isometric view of the top cover of the apparatus of FIG. 22; and,

FIG. 33 is an isometric view of a retention bar of the apparatus of FIG. 22.

### DETAILED DESCRIPTION OF PREFERRED EMBODIMENTS

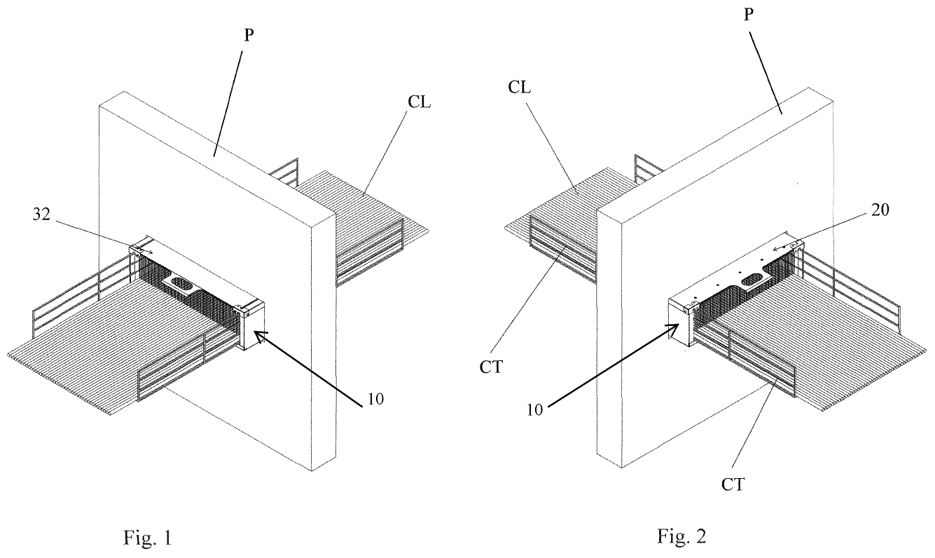

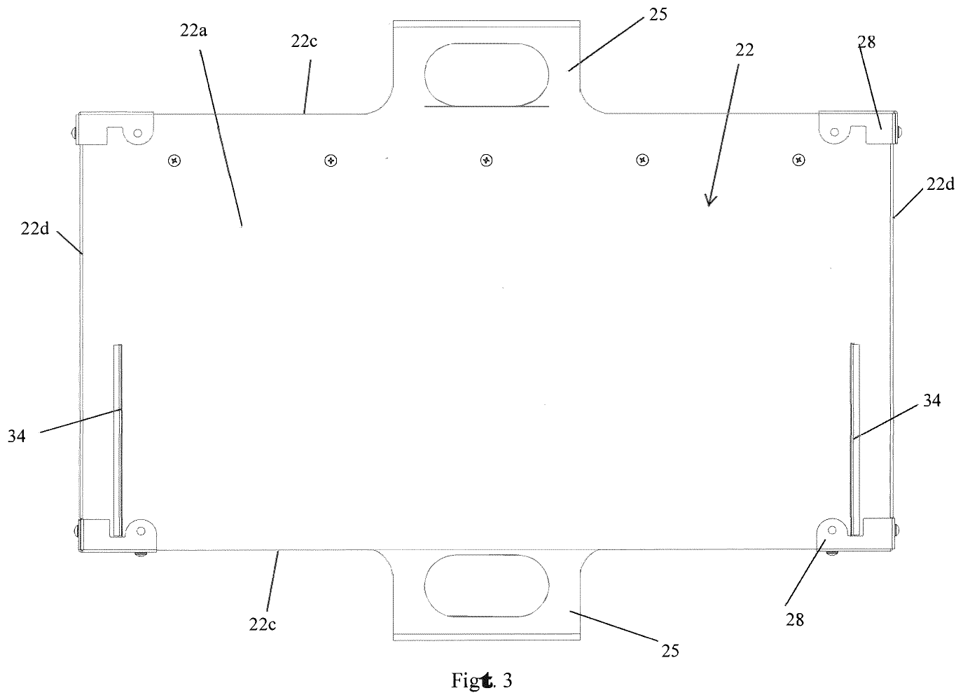

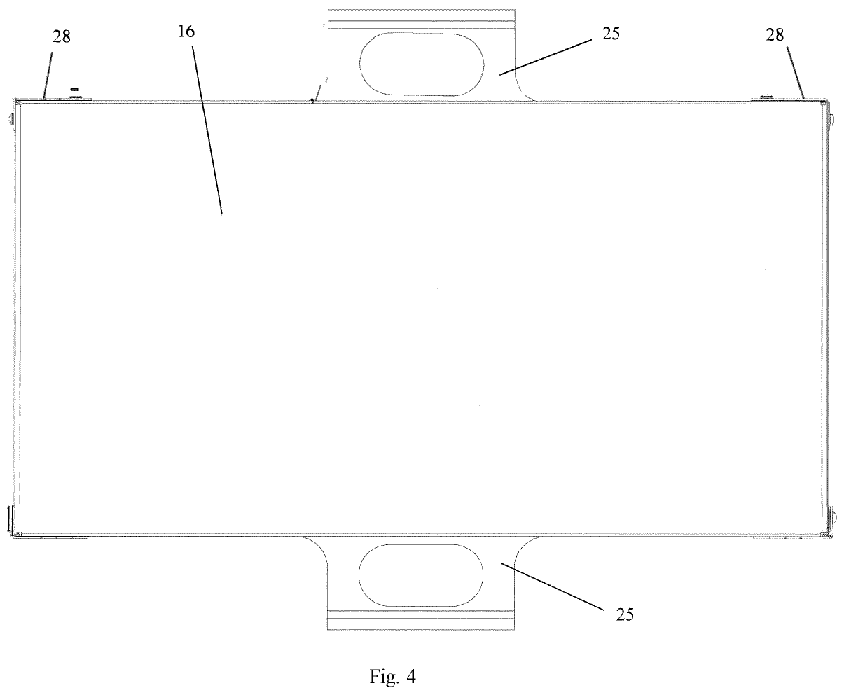

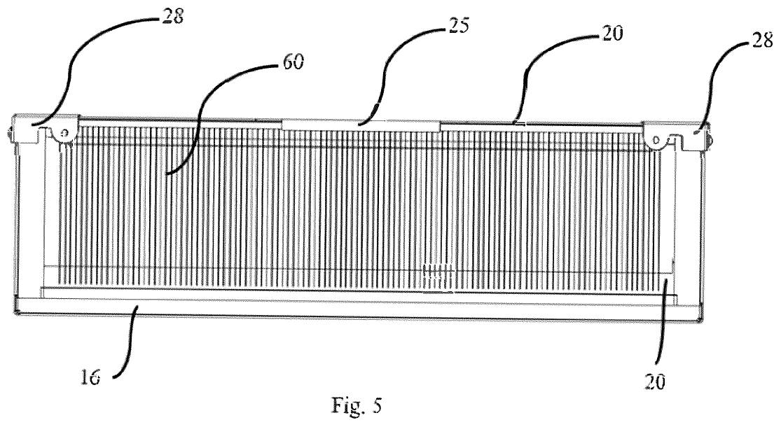

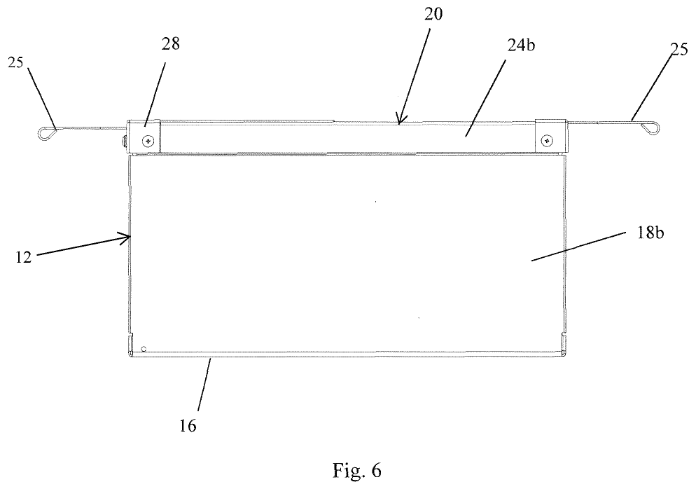

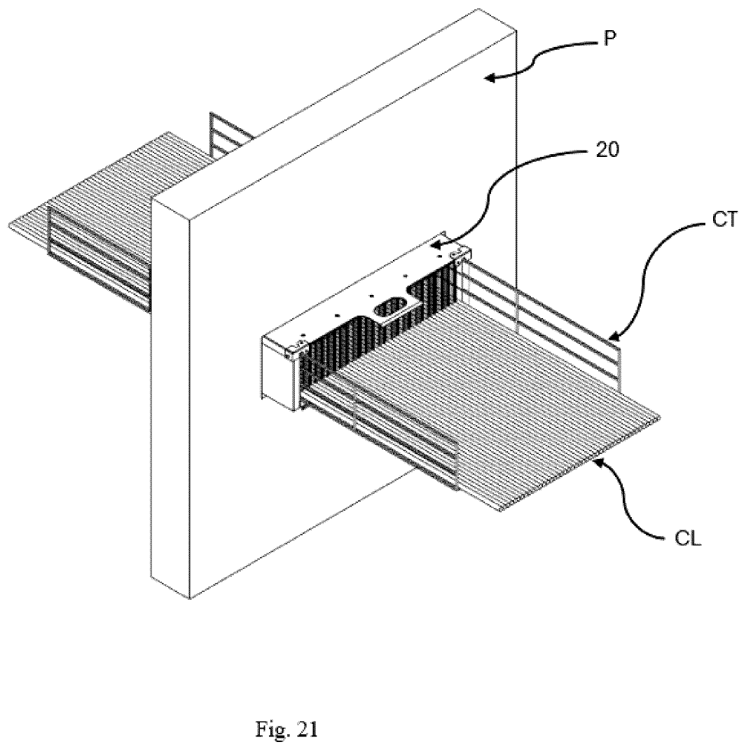

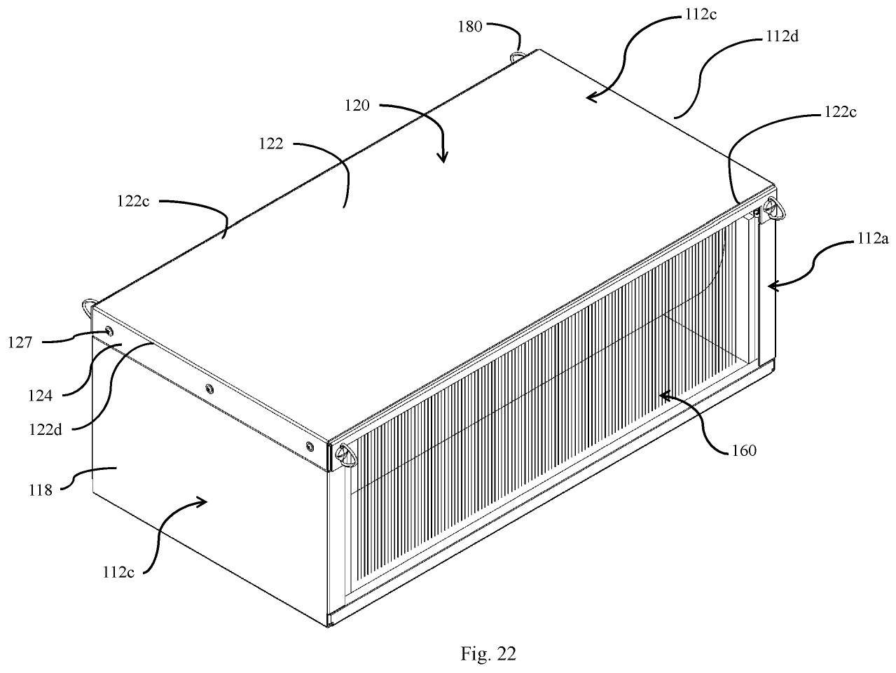

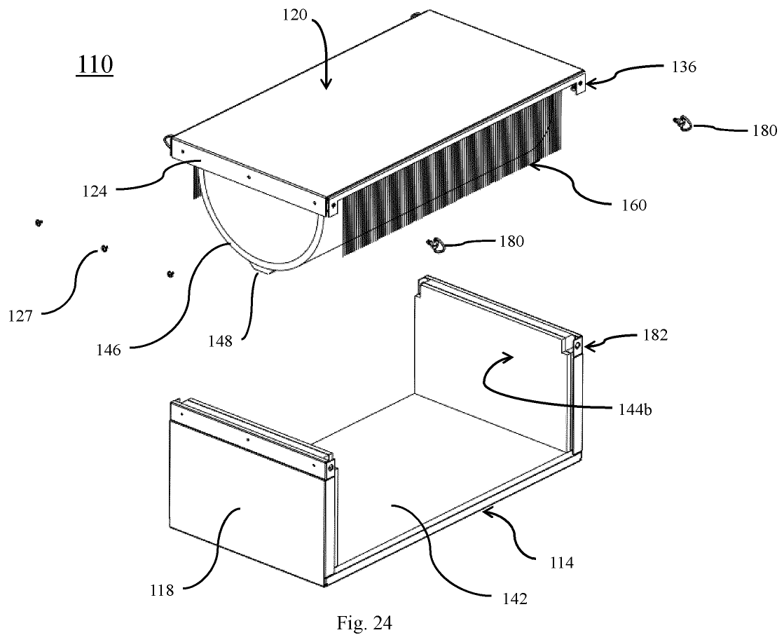

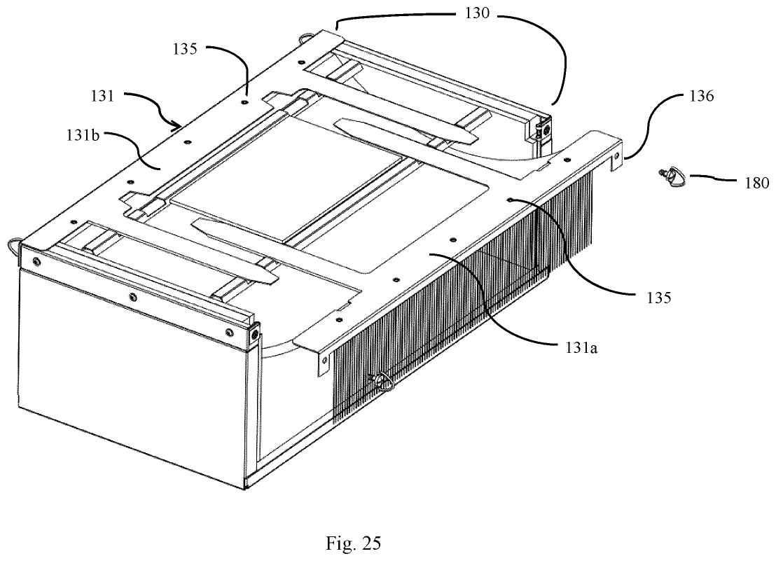

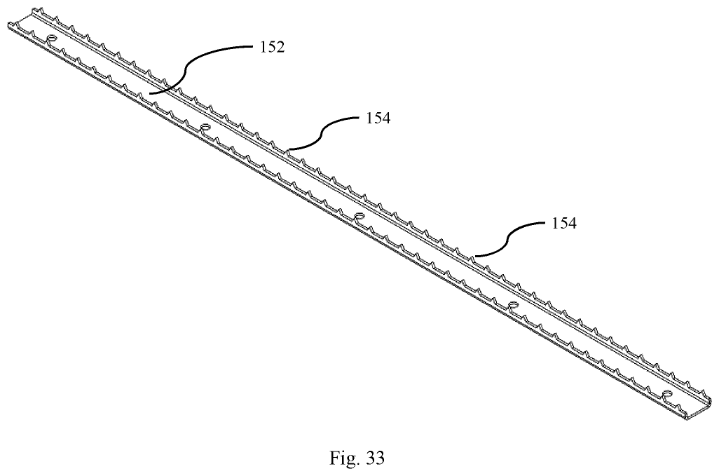

The invention is described with reference to FIGS. 1-33, and the corresponding non-limiting examples, wherein like reference numerals refer to like elements. Reference to “one embodiment” or “an embodiment” means that a particular feature, structure or characteristic described therein is included in at least one embodiment. Thus, the appearance of the phrases “in a preferred embodiment” or “in an embodiment” in various places throughout the specification are not necessarily referring to the same embodiment.

As used herein, the term “partition” refers to a wall, ceiling, floor or other structure that divides one room, floor or compartment from another. The term “utility element” refers to plumbing, electrical and communications pipe, conduit, wire and/or cable, or the like. As applied to a structural element or portion of a structural element, the point of reference for the terms “distal” and “proximal” is the bottom panel of the base of the device. The terms (and grammatical variants thereof) longitudinal, lateral, left, right, top, bottom, front and back refer to the orientation of the device shown in FIGS. 1 and 22 for the respective embodiments.

A cable tray firestopping apparatus in accordance with a first, exemplary preferred embodiment of the invention is shown in FIGS. 1-21 and is designated generally by reference numeral 10. The apparatus 10 is described with reference to use with a cable tray and cable load, designated by reference letters CT and CL, respectively. However, it should be appreciated that the apparatus 10 may be used in other applications wherein other forms of utility elements traverse a construction partition passageway, designated with reference letter P.

The apparatus 10 generally comprises a housing 12 and firestop material lining the interior of the housing 12. The apparatus 10 also includes means for selectively engaging and disengaging at least a portion of the firestop material with the cable load so that the cable load can be more easily changed or replaced.

The housing 12 defines a central (longitudinal) axis “A” and passageway through which a cable tray and a cable load extend from one side of the partition to another. The housing 12 has a generally-rectangular cross section, which size and shape complement the size and shape of the passageway in which it is installed, and the cable tray that the firestopping apparatus 10 surrounds. The housing 12 preferably has a length that is greater than the width of the partition in which it is installed. The width and height of the housing 12 may be provided in a variety of sizes to accommodate a variety of standard size cable trays.

The housing 12 includes a bottom, U-shaped base 14 and a top cover 20. The U-shaped base 14 is formed from a generally-planar bottom panel 16, and generally-planar left 18a and right 18b side panels 18. In one preferred embodiment, the side panels 18a, 18b are integrally formed with the bottom panel 16 and intersect at lower, axially-extending corners. The side panels 18 are mirror images of each other, which together with the bottom panel 16 define a generally-symmetrical construction about the central axis.

The housing has open front 12a and back 12b sides through which the cable tray and cable load extend. The left 12c and right 12d sides of the housing 12 are defined by the left 18a and right 18b side panels of the base 14.

The top cover 20 comprises a panel 22 with a top side 22a, bottom side 22b, front and back lateral (widthwise) edges 22c, left and right longitudinal (lengthwise) edges 22d, opposed left and right side flanges 24 extending from the left and right longitudinal edges 22d, and a handle 25 extending from the front lateral edge 22c. The size and shape of the top surface 22 approximates the size and shape of the bottom panel 16. In preferred embodiments, the flanges 24 are integrally formed with the top surface 22 and extend downwardly toward the base 14. The flanges 24 are configured to overlap with the opposed side panels 18 to form the housing 12. In one preferred embodiment, the top cover 20 is attached to the side panels 18 using corner brackets 28, which mechanically fasten to the side panels 18 and overlap the top corners of the top panel 20. In other embodiments, the flanges 24 may be connected directly to the side panels 18 with mechanical fasters, adhesives, crimping, welding or other fastening means.

The top cover 20 includes a pair of parallel, axially-extending slits 26, which extend through the top surface 22 from the front lateral edge to an intermediate point. The slits 26 are located proximate the longitudinal edges 22d of the top surface 22 and extend generally parallel to those edges. As described below, slides 34 on the anchor panel 30 translate within the slits 26.

The apparatus 10 includes a movable base 30 to which one end of the top firestop material is connected. In one preferred embodiment, the movable base 30 comprises a generally-planar anchor panel 32 having opposed slides 34. The anchor panel 32 has a top side 32a, bottom side 32b, front and back lateral edges 32c, left and right longitudinal edges 32d, and a handle 25 extending from the front lateral edge 32c. In one preferred embodiment, the anchor panel 32 has a generally-planar shape, a width less than the widthwise distance between the slits 26, and a length less than the length of the top cover 20. Opposed flanges 29 extend downwardly from the front lateral edge 32c.

The movable anchor panel 32 has slides 34 fixed to its the longitudinal edges 32d. In one embodiment, the slides 34 comprise L-shaped flanges 36 having a vertical portion 36a and a horizontal portion 36b. The flanges 36 are preferably integrally-formed with and extend along at least a portion of the length of the longitudinal edges 32d of the anchor panel using a brake or other manufacturing equipment. The vertical portion 36a of the flange is configured to slide within the slits 26 of the top cover 20. The horizontal portion 36b of the flanges is configured to slide on the tops surface of the top cover 20 along the area immediately adjacent the slits 26 as further described below.

In alternative embodiments, the slides 34 comprise separate elements that are fixed to the longitudinal edges 32d or other portions of the anchor panel 32. In other embodiments, the slides 34 have different shapes and/or different constructions that allow the anchor panel 32 to slide along generally co-planar with, or telescope with, the top cover 20.

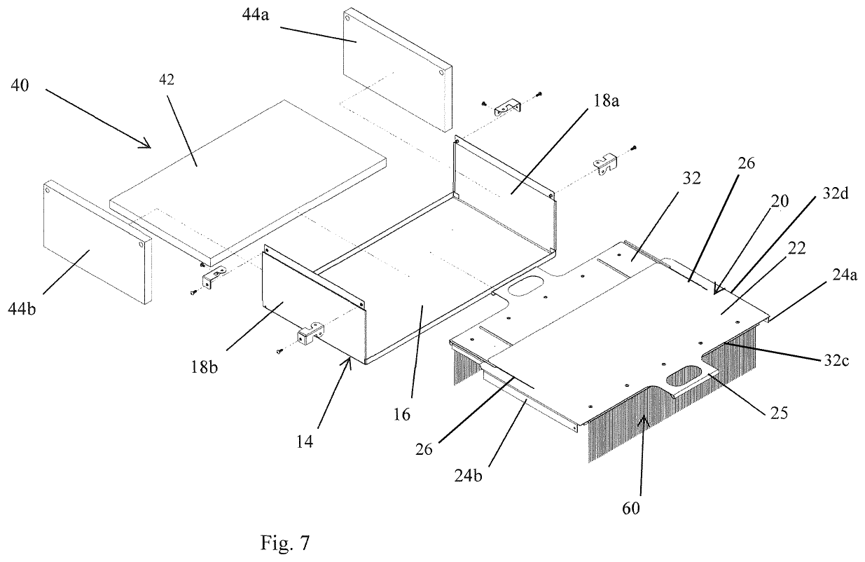

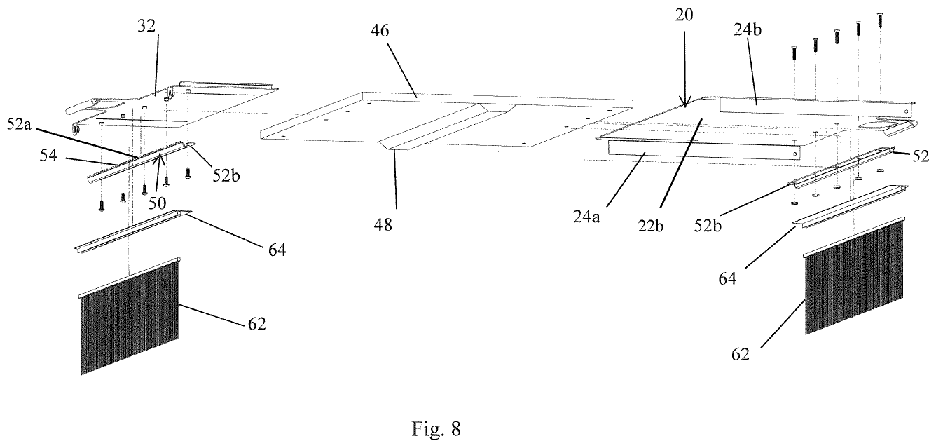

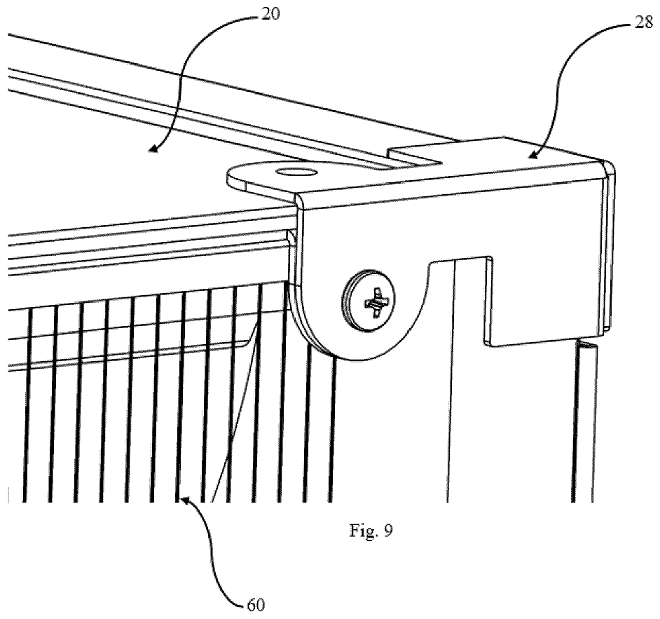

Referring to FIGS. 7 and 8, intumescent firestop material 40 lines the inner surfaces of the housing 12. In preferred embodiments, the firestop material 40 comprises a bottom pad 42, left 44a and right 44b side pads, and a top pad 46. In preferred embodiments, the bottom pad 42 and the side pads 44 are generally planar and are fixed to the inside surfaces of the housing 20 with pressure-sensitive adhesive applied over large portions of the contact area.

The top pad 46 is also generally planar but preferably includes a central, laterally-extending strip of fire-retardant foam 48 that enhances the ability of the top pad 46 to adapt to cables of varying diameters and accommodate different positions of the cables within the device. The foam 48 also reduces leakage, smoke propagation, and limits the potential visible light that may pass through if the surface is fully compressed and hard to compress. In the embodiment shown in FIGS. 1-21, the foam has a trapezoidal cross section shape secured to the top pad 46.

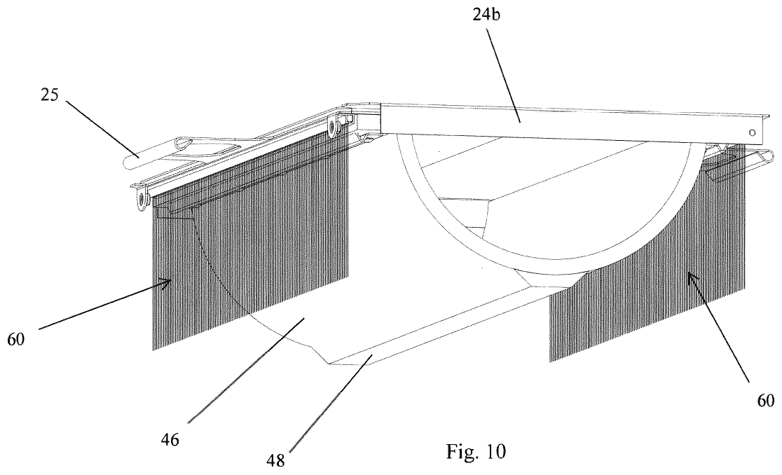

Unlike the bottom 42 and side pads 44, which have large contact areas adhered to the housing, the top pad 46 is not adhered to the top cover 20. Instead, it is clamped at two ends and suspended within the housing. As best seen in FIGS. 10-15, the back end of the top pad 46 is secured to the back end of the top cover 20, and at the front end of the top pad 46 is secured to the anchor panel 32. In one preferred embodiment, the top pad 46 is clamped using retention bars 50 that are fixed to the top cover 20 and anchor panel 32. Referring to FIG. 8, the retention bars comprise elongate straps 52 having gripping teeth 54 along at least a central portion 52a of the straps 52. The straps 52 are removably, mechanically fastened to the top cover 20 and anchor panel 32 by a plurality of screws extending through the mounting flange 52b on the straps 52. The straps 52 have a width and thickness that preferably enables them to be flexed along their longitudinal axis when installed over the top pad 46 and fastened to the top cover 20 and anchor panel 32.

The teeth 54 of the retention bars 50 protrude outwardly from one side of the straps 52. In one preferred embodiment, the teeth are integrally formed with the straps 52 such as by stamping a thin metal strip and bending the teeth generally perpendicular to the plane of the strip. The teeth 54 are configured to dig into the flexible, top pad 46 when the retention bars 50 are screwed into the top cover 20 and slidable anchor panel 32. The teeth 54 prevent the top pad 46 from slipping out from under the retention bars 50.

The intumescent pads 42, 44, 46 are designed to expand rapidly when exposed to fire or high heat and seal the gap between the cable load and the inside of the housing 12. The seal formed by the firestop pads prevents fire and smoke from traversing the partition through the passageway in the apparatus 10. Preferably, the firestop pads comprise intumescent materials. The intumescent materials preferably include a foam component chosen of one of various polymers such as polyurethane or silicone or any other polymer, which has the capability of forming a soft resilient foam. The intumescent component of the foam may include expandable graphite, sodium silicate or any other commonly used expansion ingredient that is compatible for use with the basic foam carrier construction. In this regard, the intumescent pads 42, 44, 46 function the same was as the intumescent pads disclosed in U.S. Pat. No. 11,124,963, incorporated herein by reference.

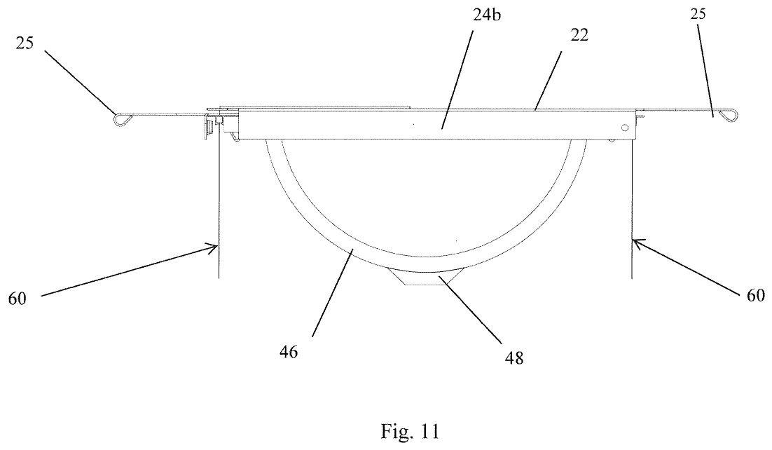

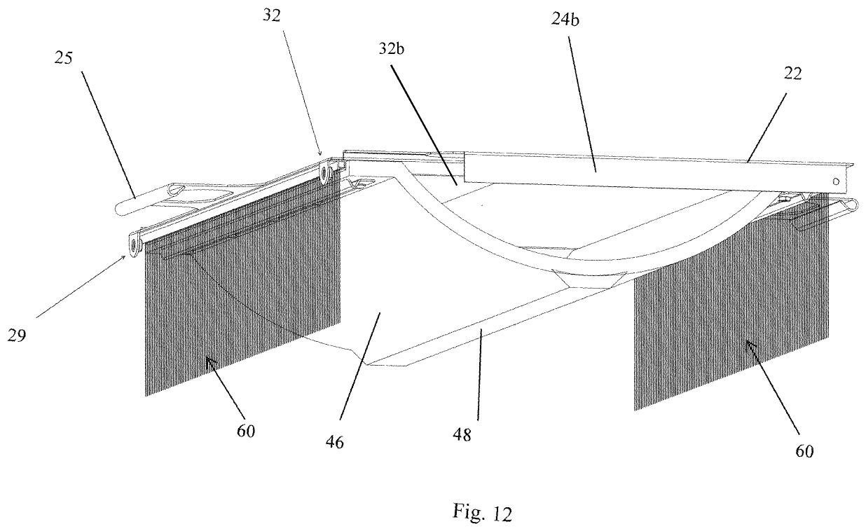

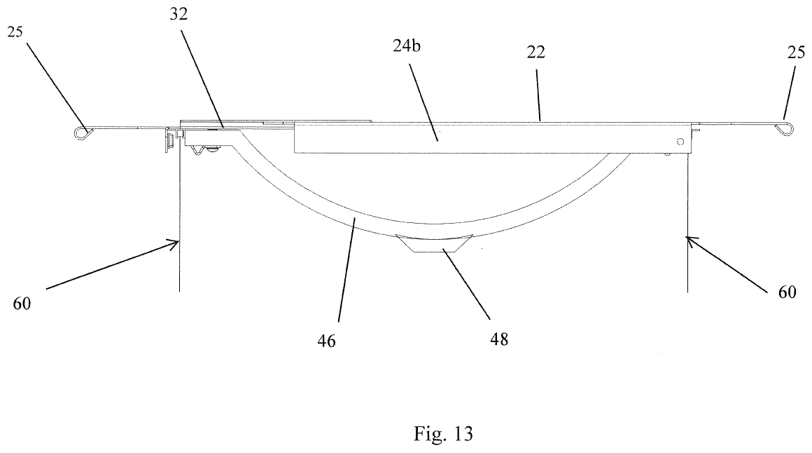

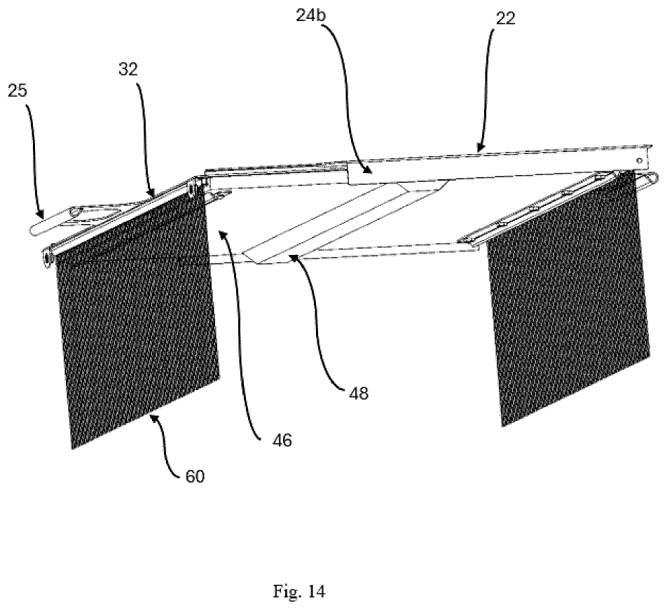

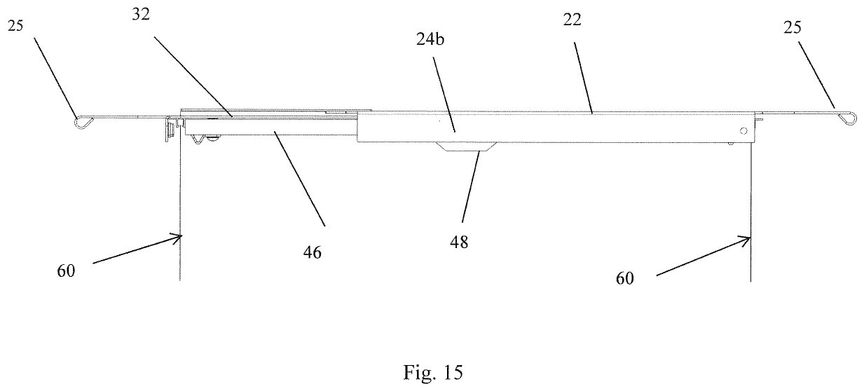

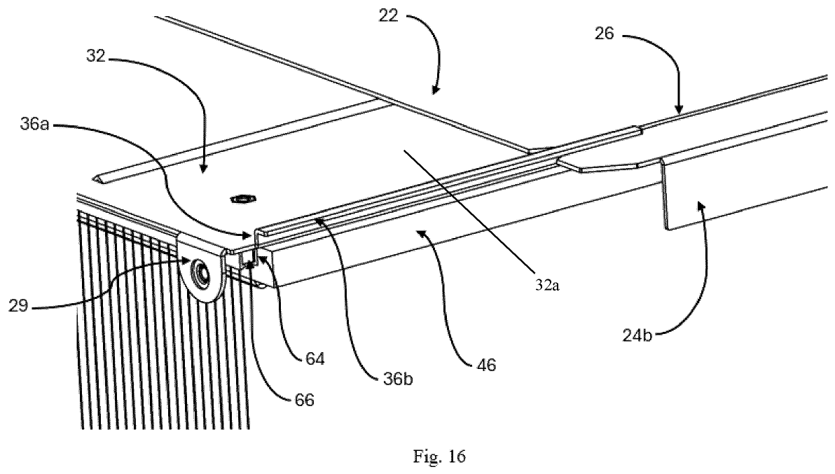

In one preferred embodiment, the slidable anchor panel 32 functions as the means for selectively engaging and disengaging at least a portion of the intumescent material with the cable load. The slidable anchor panel 32 translates within the housing in the longitudinal direction between a closed limit position in which the anchor panel 32 is positioned entirely within the housing 12 as shown in FIGS. 10 and 11, intermediate positions shown in FIGS. 12 and 13, and an open limit position extending outwardly from the housing as shown in FIGS. 14 and 15. The length and thickness of the top intumescent pad 46 are selected so that when the anchor panel 32 is moved to its open position, the top intumescent pad 46 is pulled taut almost horizontal as seen in FIGS. 14 and 15, and is disengaged from the cable load. In this open position, a large gap is created between the cable load and the top intumescent pad 46, through which existing cables may be removed or new cables added without obstruction from the top pad 46. In the closed position shown in FIGS. 10 and 11, the top pad 46 suspends downwardly into engagement with the cable load extending through the housing 12. Due to its rigidity, the top intumescent pad 46 is compressed against the cable load and provides a tight seal to minimize smoke leakage and maximize resistance to fire. Because the top pad 46 is flexible and includes a compressible foam strip 48, the top pad conforms its shape to the cable load to which it engages, and can therefore accommodate cable loads of different sizes and geometries.

Optionally, the apparatus 10 includes brush assemblies 60 covering the front and back openings of the housing 12. Referring to FIG. 8, the brush assemblies 60 generally comprise a brush mount 64 and a linear array of bristles 62 fixed to and extending from the brush base 66.

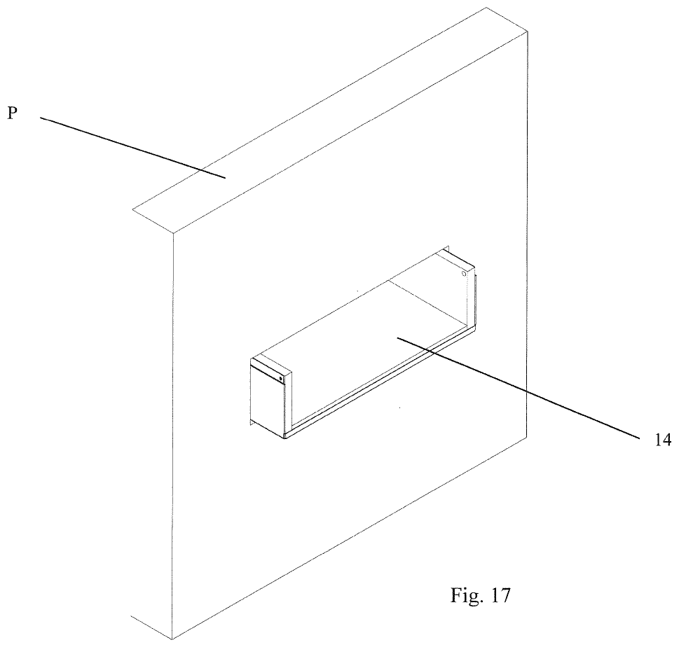

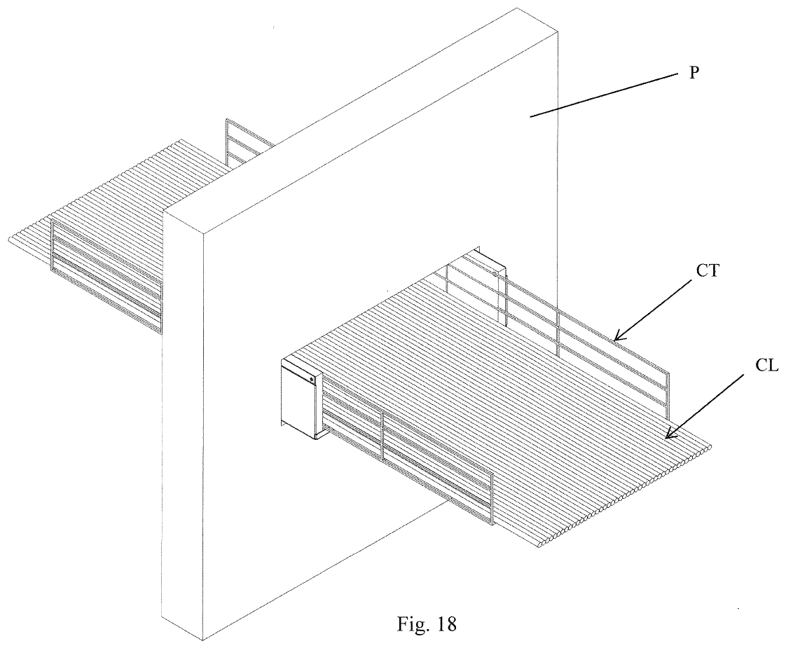

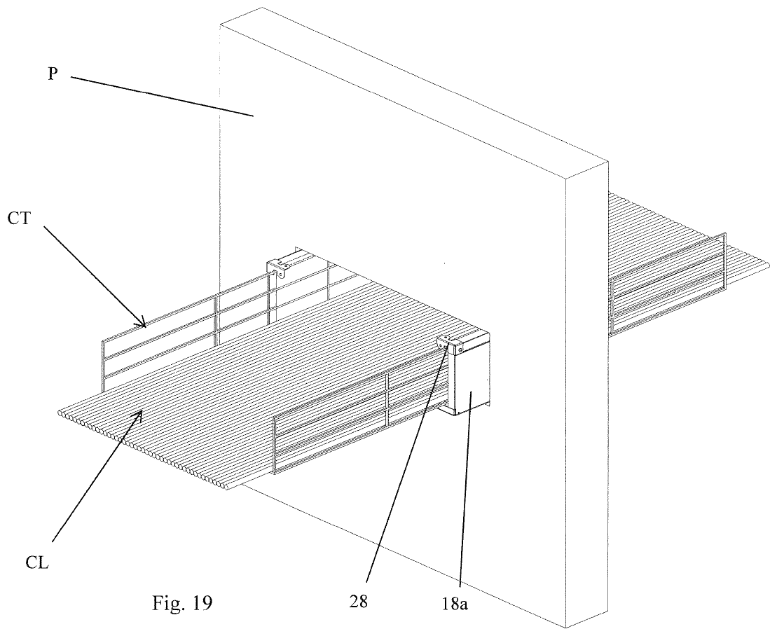

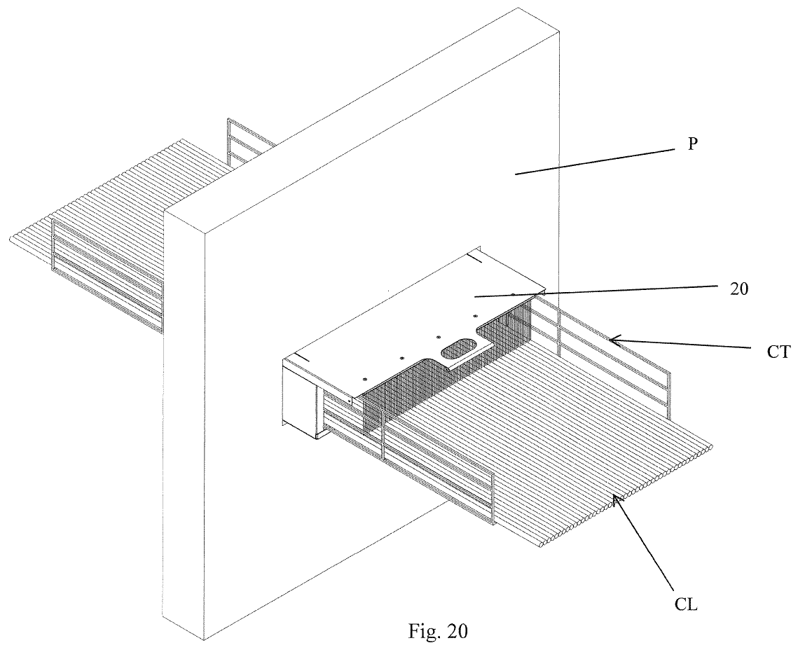

FIGS. 17-21 illustrate the preferred steps for installing the apparatus 10 in a partition passageway P and around a cable tray. Initially, the U-shaped base 14 is installed in the passageway as shown in FIG. 17. Next, the cable tray is installed in the base 14 and loaded with cables as seen in FIG. 18. Corner brackets are installed at one end of the base 14 as shown in FIG. 19. Then, the cover assembly is installed on the base 14 as shown in FIG. 20. Finally, the cover assembly is closed and the final two corner brackets are installed at the other end of the base to secure the cover assembly in the closed position on the base.

A cable tray firestopping apparatus in accordance with another exemplary preferred embodiment of the invention is shown in FIGS. 22-33 and is designated generally by reference numeral 110. The apparatus 110 is described with reference to use with a cable tray and cable load as described above with respect to the embodiment of FIGS. 1-21. However, it should be appreciated that the apparatus 110 may be used in other applications wherein other forms of utility elements traverse a construction partition passageway.

The apparatus 110 generally comprises a housing 112 and intumescent material 140 lining the interior of the housing 112. The apparatus 110 also includes means for selectively engaging and disengaging at least a portion of the intumescent material 140 with the cable load so that the cable load can be more easily changed or replaced.

The housing 112 defines a central (longitudinal) axis “A” and passageway through which a cable tray and a cable load extend from one side of the apparatus 110 to the other. When the apparatus 110 is installed in a passageway in the partition, the cable tray and cable load extend through the partition from one side to the other.

The housing 112 has a generally-rectangular cross section, which size and shape complement the size and shape of the passageway in which it is installed, and the cable tray that the firestopping apparatus 110 surrounds. The housing 112 preferably has a depth that is greater than the thickness of the partition in which it is installed. The width and height of the housing 112 may be provided in a variety of sizes to accommodate a variety of standard size cable trays.

The housing 112 includes a bottom, U-shaped base 114 and a top cover 120. The U-shaped base 114 is formed from a generally-planar bottom panel 116, and generally-planar left and right side panels 118. In one preferred embodiment, the side panels 118 are integrally formed with the bottom panel 116 and intersect at lower, axially-extending corners. The side panels 118 are mirror images of each other, which together with the bottom panel 116 define a generally-symmetrical construction about the central axis.

The housing has open front 112a and back 112b sides through which the cable tray and cable load extend. The left 112c and right 112d sides of the housing 12 are defined by the left and right side panels 118 of the base 114.

The top cover 120 comprises a top panel 122 with a top side 122a, bottom side 122b, front and back lateral (widthwise) edges 122c, left and right longitudinal (lengthwise) edges 122d, and opposed left and right side flanges 124 extending downwardly from the left and right longitudinal edges 122d. The apparatus 110 has a symmetrical construction about the central axis; therefore, the terms left, right, front and back reference the orientation shown in FIG. 22. The size and shape of the top panel 122 approximates the size and shape of the bottom panel 116. In preferred embodiments, the flanges 124 are integrally formed with the top panel 122 and extend downwardly toward the base 114. The flanges 124 are configured to overlap with the opposed side panels 118 to form the housing 112. In one preferred embodiment, the top cover 120 is attached to the side panels 118 using fasteners 127 such as self-tapping screws, which extend through aligned holes in the flanges 124 and the side panels 118. In other embodiments, the flanges 124 may be connected to the side panels 118 with adhesives, crimping, welding or other fastening means.

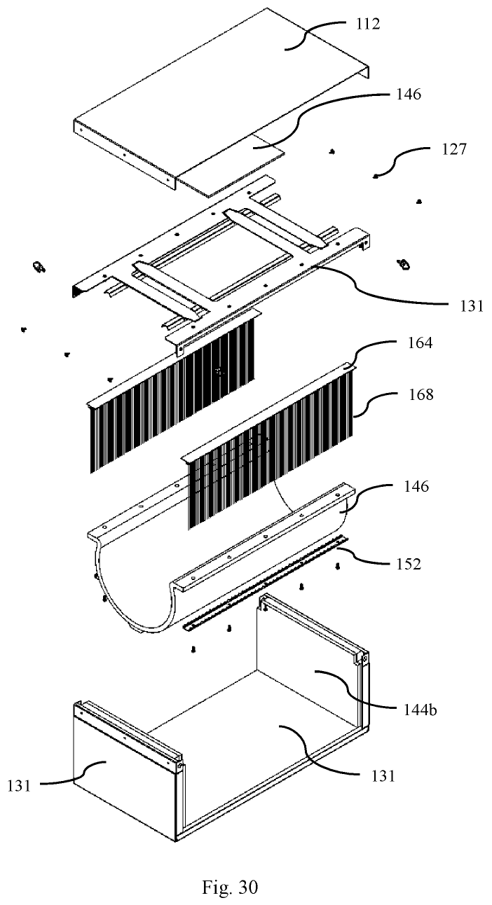

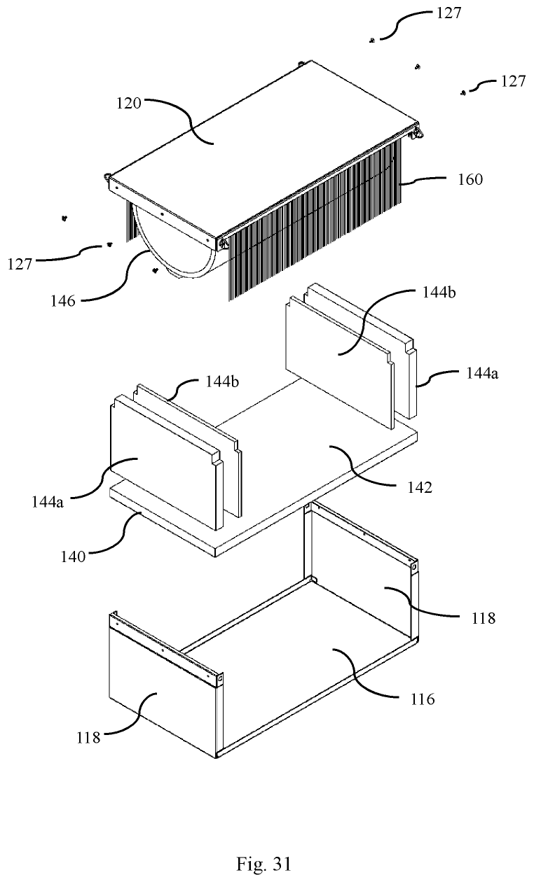

Referring to FIGS. 30 and 31, firestop material 140 lines the inner surfaces of the housing 112. In preferred embodiments, the firestop material 140 comprises a bottom firestop pad 142, left and right side firestop pads 144, and a top firestop pad 146. In preferred embodiments, the bottom pad 142 comprises a compressible intumescent foam to provide thermal insulation and fire resistance. In preferred embodiments, the side pads have a dual-layer configuration. The inner layer 144a (relative to the side panels 118) comprises an intumescent polyurethane foam fixed to the inner, side panes 118 of the housing. The outer layer 144a comprises a fire-retardant, open-cell foam that is more compressible than the inner, intumescent material, which allows for better conformity and a snug, protective fit around cable trays CT and the cable load CL. The bottom pad 142 and side pads 144 are generally planar and are fixed to the inside surfaces of the housing 120 with pressure-sensitive adhesive applied over large portions of the contact area.

The top pad 146 is also generally planar but preferably includes a central, laterally-extending strip of fire-retardant foam strip 148 that enhances the ability of the top pad 146 to adapt to cables of varying diameters and accommodate different positions of the cables within the device. The foam strip 148 also reduces leakage, smoke propagation, and limits the potential visible light that may pass through if the surface is fully compressed and hard to compress. In the embodiment shown in FIGS. 22-33, the foam strip 148 has a trapezoidal cross section and is secured to the top pad 146.

Unlike the bottom pad 142 and side pads 144, which have large contact areas adhered to the inner walls of the housing, the top pad 146 is not adhered to the top cover 120. Instead, it is fixed at opposed ends to an actuator 130, which moves the top pad 146 into and out of engagement with the cable load to allow easier alteration of the cable load.

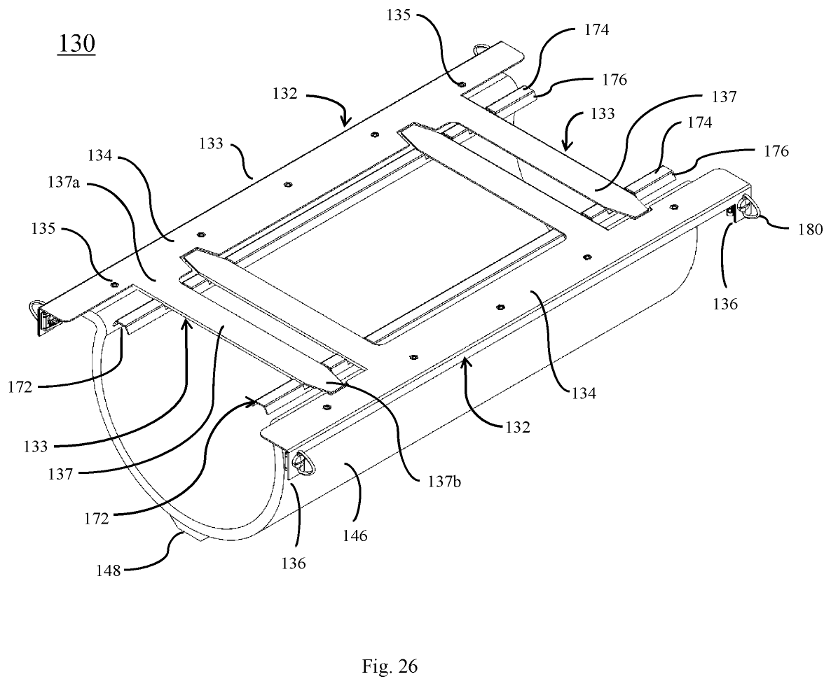

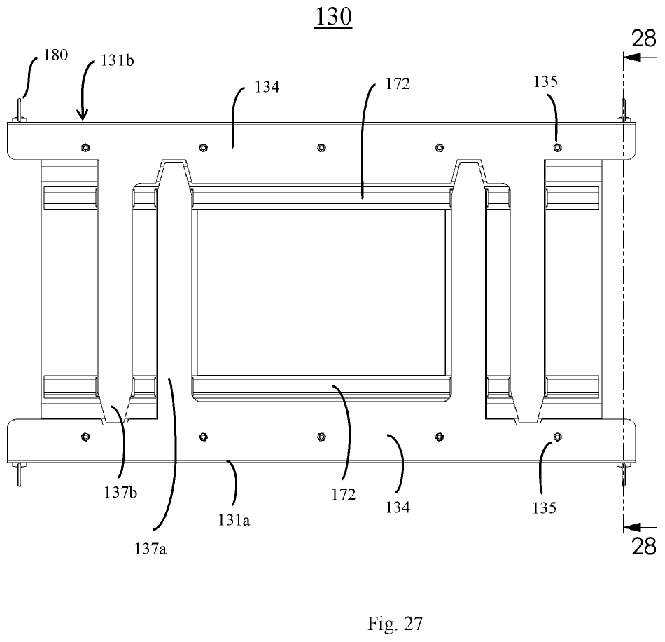

In one preferred embodiment, the actuator 130 comprises a pair of slider brackets 131 that engage and slide within a pair of guides 170. In preferred embodiments, each bracket 131 generally comprises a carriage 132 and a pair of arms 133 fixed the carriage 132. Referring to FIGS. 26 and 27, the carriage 132 comprises a transversely-extending, flat bar 134 having a plurality of threaded fastener holes 135, and a mounting bracket 136 on each end of the bar 134. Referring to FIG. 27, the flat bars 134 are wider in the middle portion, which adds structural stability to the brackets 131 since they are generally thin compared to their widthwise and lengthwise dimensions.

The arms 133 generally comprise an axially-extending flat bar 137 fixed at a proximal end 137a to the carriage 132 flat bar 134 and tapered at a distal end 137b. In preferred embodiments, the carriage 132 is integrally formed with the arms 133, but may comprise separately-joined elements.

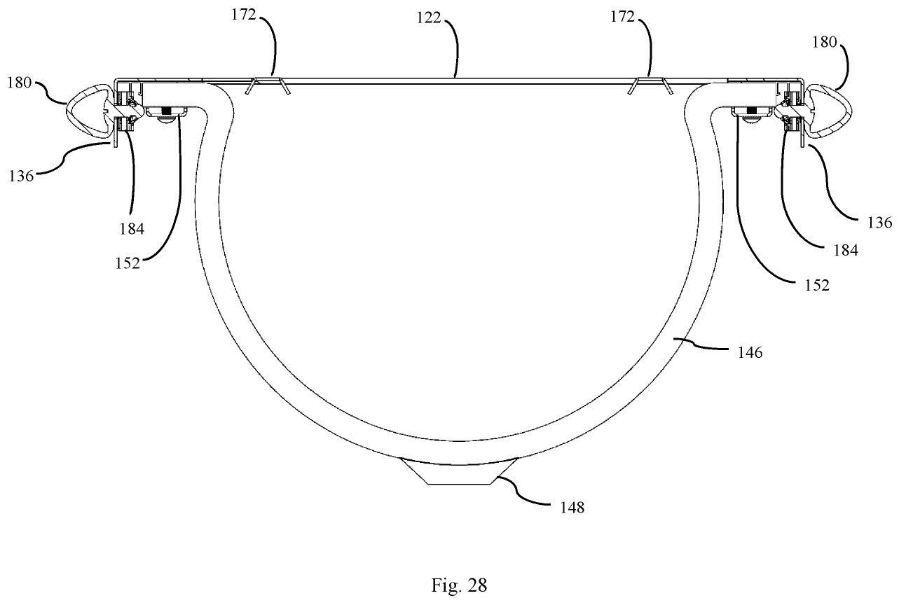

In one preferred, exemplary embodiment, the brackets 131 are mounted in a coplanar configuration as best seen in FIG. 28. The common plane is parallel to the top panel 122 to which the guides 170 are fixed. To enable the arms 133 of opposed brackets 131 to interdigitate within the common plane, the spacing between arms on one bracket 131 is different than the spacing of the arms 133 on the other bracket 131 as best seen in FIG. 27. In one embodiment, the arms 133 on a first (inner) bracket 131a are more centrally located while the arms 133 on a second (outer) bracket 131b are located closer to the axial ends of the carriage 132. In other preferred embodiments, the arms 133 can be arranged in an alternating pattern.

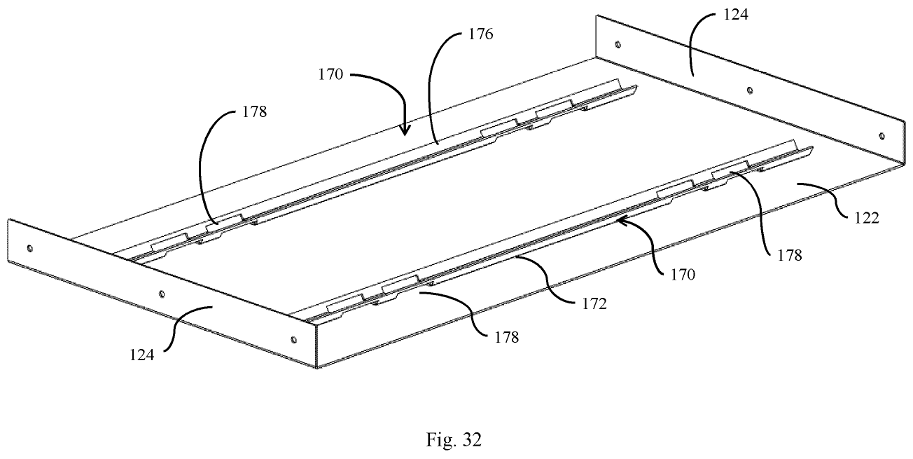

In one exemplary preferred embodiment, the guides 170 comprise elongate, U-shaped channel beams 172 having a central flat base 174 and opposed legs 176 extending at an obtuse angle relative to the base 174. A plurality of transverse-extending slits 178 are formed in the beams as best seen in FIG. 32. In this embodiment, the slits 178 extend from one leg 176 to the other and through the base 175, thereby forming axially-extending passageways through which the arms 133 of the brackets 131 may translate by sliding. The slits 178 are preferably slightly larger than the height-width profile of the arms 133, and are aligned with one of the arms 133. The beams 172 are fixed to the underside (inside) of the top panel 122 in a transverse orientation relative to the central axis A as best seen in FIG. 32. Preferably, the base 174 of the beams 172 is fixed flat against the underside of the top panel 122 with the legs 176 of the beams 172 projecting outwardly from the top panel 122. Because the slits 178 are transversely aligned with the arms 133 and are larger than cross-sectional dimensions of the arms 133, the arms 133 can slide through the slits 178, which enables the brackets 131 to slide toward and away from the front and back faces of the housing as seen comparing FIGS. 22, 23 and 25.

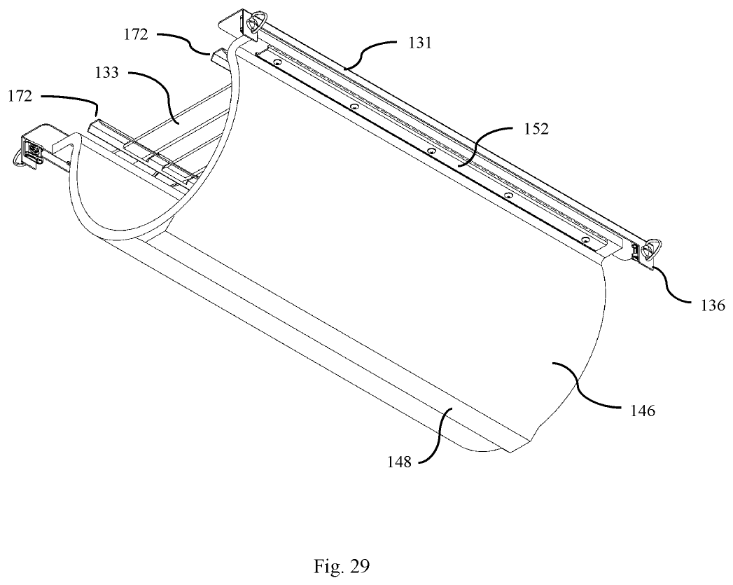

Similar to the embodiment shown in FIGS. 1-21, the top pad 146 is suspended within the housing as best seen in FIGS. 28 and 29. In one exemplary preferred embodiment, each transverse-extending edge of the top pad 146 is fixed to the carriage 132 of each bracket 131 as best seen FIGS. 28 and 29. In one preferred embodiment, the top pad 146 is clamped using retention bars 150 that are fixed to the carriage 132 of each slider bracket 131. In one preferred embodiment, the retention bars 150 comprise elongate straps 152 having gripping teeth 154 along the length of the straps 152. The straps 152 are removably, mechanically fastened to the brackets 131 with screws that extend through the straps 152, through holes in the top pad 146, and into threaded holes in the carriage 132 of the bracket 131.

The teeth 154 of the retention bars 150 protrude outwardly from both sides of the straps 152. In one preferred embodiment, the teeth 154 are integrally formed with the straps 152 such as by stamping a thin metal strip and bending the teeth generally perpendicular to the plane of the strap 152. The teeth 154 are configured to dig into the flexible, top pad 146 when the retention bars 150 are screwed into the brackets 131. The teeth 154 prevent the top pad 146 from slipping out from under the retention bars 150.

As compared to the embodiment shown in FIGS. 1-21, both slider brackets 131 are movable from the closed position to the open position, thereby providing functionality on both sides of the partition. The slider brackets 131 are held in the closed position by quick release fasteners 180, which extend through holes in the corner mounting brackets 136 of the mounting brackets 131 and engage a tab 182 on the face of the housing. In one preferred embodiment, the quick release fasteners comprise quarter-turn screws, which are held on the brackets 136 by retaining clips 184. To move the slider brackets 131 to an open position, the operator turns the quick-release fasteners 180 to the open position, and then pulls/slides the bracket 131 away from the housing.

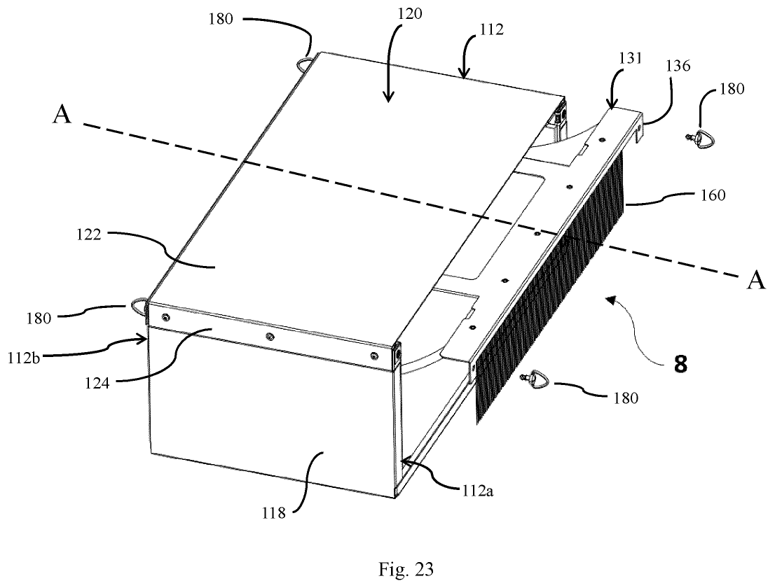

The slider brackets 131 translate within the housing in the axial direction between a closed position in which the slider brackets 131 are positioned entirely within the housing 112 as shown in FIG. 22, and an open position extending outwardly from the housing as shown in FIG. 23. The length and thickness of the top intumescent pad 146 are selected so that when one of the slider brackets is moved to its open position, the top intumescent pad 146 is pulled taut almost horizontal, and is disengaged from the cable load. In the open position, a large gap is created between the cable load and the top intumescent pad 146, through which existing cables may be removed or new cables added without obstruction from the top pad 146. In the closed position, the top pad 146 projects downwardly into engagement with the cable load extending through the housing 112. Due to its rigidity, the top intumescent pad 146 is compressed against the cable load and provides a tight seal to minimize smoke leakage and maximize resistance to fire. Because the top pad 146 is flexible and includes a compressible foam pad 148, in the closed position the top pad conforms to the size and shape of the cable load, and is therefore reconfigurable to accommodate different cable load sizes and geometries.

Optionally, the apparatus 110 includes brush assemblies 160 covering the front and back openings of the housing 112. The brush assemblies 160 generally comprise a brush mount 164 and a linear array of bristles 168 fixed to and extending from the brush mount 164.

Similar to the embodiment of FIGS. 1-21, the firestop pads 142, 144, 146 are designed to expand rapidly when exposed to fire or high heat and seal the gap between the cable load and the inside of the housing 112. The intumescent materials preferably include a foam component chosen from one of various polymers such as polyurethane or silicone or any other polymer, which has the capability of forming a soft resilient foam. The intumescent component of the foam may include expandable graphite, sodium silicate or any other commonly used expansion ingredient that is compatible for use with the basic foam carrier construction. In this regard, the firestop pads 142, 144, 146 function the same way as the intumescent pads disclosed in U.S. Pat. No. 11,124,963, incorporated herein by reference.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

Although the invention has been illustrated by reference to specific embodiments, it will be apparent that the invention is not limited thereto as various changes and modifications may be made thereto without departing from the invention scope. The various embodiments are intended to be protected broadly within the spirit and scope of the appended claims. The terms and expressions have been used as terms of description and not limitation. There is no limitation to use the terms or expressions to exclude any equivalents of features shown and described or portions thereof.

1. An apparatus for firestopping a cable tray having a cable load and extending through a partition, comprising:
a. a housing having top, bottom, side panels and central, longitudinal axis, and constructed to envelope a portion of the cable tray within the partition and defining an axial passageway between open front and back sides through which the cable tray and cable load extend;
b. fixed firestop material arranged along the inside of at least one of said top, bottom and side panels and around said axial passageway;
c. movable firestop material arranged along the inside of at least one of said top, bottom and side panels and around said axial passageway; and,
d. an actuator connected to said movable firestop material,
wherein said actuator is constructed and arranged to translate said movable firestop material between a first position disengaged from the cable load, which allows the cable load to be altered without interference from said movable firestop material, and a second position engaged with the cable load, which firestops the passageway surrounding the cable load.

2. The apparatus recited in claim 1, wherein said movable firestop material is reconfigurable in the second position to accommodate different cable load sizes and geometries.

3. The apparatus recited in claim 2, wherein said movable firestop material comprises a flexible pad including an intumescent material.

4. The apparatus recited in claim 3, wherein said actuator comprises a guide fixed to one of said housing panels.

5. The apparatus recited in claim 4, wherein said actuator comprises a movable bracket that reciprocates within said guide.

6. The apparatus recited in claim 5, wherein one edge of said flexible pad is fixed to said movable bracket and an opposed edge is fixed to said housing so that said flexible pad is configured into different geometries when said movable bracket is moved relative to the housing.

7. The apparatus recited in claim 5, wherein said movable bracket comprises a carriage to which said movable firestop material can be fixed, and arms connected to said carriage that slide within said guide.

8. The apparatus recited in claim 7, wherein said actuator is operable from either the front or back side of the housing.

9. The apparatus recited in claim 8, wherein said actuator comprises a pair of brackets that are movable relative to one another.

10. The apparatus recited in claim 9, wherein opposed edges of said flexible pad are fixed to one of said brackets so that said flexible pad is configured into different geometries when at least one of said brackets is moved relative to the other bracket.

11. The apparatus recited in claim 10, wherein said brackets are constructed and arranged so that the arms interdigitate within a common plane parallel to the panel to which said guide is fixed.

12. The apparatus recited in claim 1, wherein said fixed firestop material comprises pads of intumescent material fixed to at least one of said bottom and sidewalls of said housing.

13. The apparatus recited in claim 12, wherein at least a portion of said fixed intumescent material comprises a multi-layer pad having a layer of intumescent foam and a layer of compressible, fire-retardant foam.

14. The apparatus recited in claim 13, wherein said multi-layer pads are fixed to the sidewalls of said housing.

15. The apparatus recited in claim 3, wherein said flexible pad includes a compressible, intumescent foam pad.

16. An apparatus for firestopping a cable tray having a cable load and extending through a partition, comprising:
a. a housing having top, bottom, side panels and central, longitudinal axis, and constructed to envelope a portion of the cable tray within the partition and defining an axial passageway between open front and back sides through which the cable tray and cable load extend;
b. fixed firestop material arranged along the inside of said bottom and side panels and around said axial passageway;
c. movable firestop material arranged proximate said top panel and around said axial passageway; and,
d. an actuator connected to top panel and connected to said movable firestop material at opposed ends to suspend said movable firestop material within the housing above the bottom panel;
wherein said actuator is operable from either the front or back side of the housing, and is constructed and arranged to change the suspension of said movable firestop material and move said movable firestop material between a first position disengaged from the cable load, which allows the cable load to be altered without interference from said movable firestop material, and a second position engaged with the cable load, which firestops the passageway surrounding the cable load.

17. The apparatus recited in claim 16, wherein said movable firestop material comprises a flexible pad that is reconfigurable in the second position to accommodate different cable load sizes and geometries.

18. The apparatus recited in claim 17, wherein said actuator comprises a guide fixed to said top panel, and a plurality of brackets that translate within said guide and are fixed to opposed edges of said flexible pad so that said flexible pad is configured into different geometries when said brackets slide within said guide.

19. The apparatus recited in claim 18, wherein said movable bracket comprises a carriage to which said movable firestop material can be fixed, and arms connected to said carriage that slide within said guide. The apparatus recited in claim 1, wherein said fixed firestop material comprises pads of intumescent material fixed to at least one of said bottom and sidewalls of said housing.

20. The apparatus recited in claim 19, wherein said firestop material on said side panels comprises a multi-layer pad having an inner layer of intumescent foam and an outer layer of compressible, fire-retardant foam.
